(19) United States
(12) Patent Application Publication
(10) Pub. No.: US 2008/0222950 A1
(43) Pub. Date: Sep. 18, 2008

(54) Method and apparatus for planting seeds and growing plants

(76) Inventors: Brian Rooker, Redondo Beach, CA (US); Teresa Rooker, Redondo Beach, CA (US)

Correspondence Address: Phil Virga;#105, 1525 Aviation Blvd., Redondo Beach, CA, 90278, US

(21) Appl. No.: 11/717,282

(22) Filed: Mar. 14, 2007

(51) Int. Cl. A01G 9/02

(52) U.S. Cl. 47/65.5

(57) ABSTRACT

A method and apparatus for planting seeds and growing plants comprises a base member housing one or more planting tubes and an extraction rod. In use soil is placed in a planting tube with seedling thereby creating a potting medium. When the seedling grows to a desired size the planting tube is removed from the base member and placed over the extraction rod wherein it is gently pushed downward over the extraction rod thereby removing the potting medium and seedling from the planting tube for transplantation.

### FIELD OF THE INVENTION

The present invention relates to methods and apparatus for planting and nurture of growing plants, particularly those which efficiently utilize growing space and minimize associated costs and labor.

### BACKGROUND

Numerous apparatus and methods have been put forth for the germination of seeds and initial growth of the plants for subsequent replanting. The most common of these involve the germination and initial growth of the plant within an individual container such as a cup, pot or the like, followed by replanting into the final growth environment when the root system has grown appropriately within the confines of the container. The initial growing containers are often grouped into a single structure. For example, U.S. Pat. No. 3,667,159, features a group of chambers each upwardly flared to facilitate the removal of the plant, along with the initial seed germinating medium, for subsequent replanting. Additionally, it is known in the prior art that similar plant apparatus are adapted for removal of the plant and potting medium for subsequent replanting into a final growing environment. All of these methods and apparatus are subject to the traditional problems of damaging the plant or potting medium during removal from the initial plant apparatus.

Such removal is sometimes quite difficult and frequently results in damage or injury to the seedlings, not to mention the labor costs involved in the removal of the seedlings from such containers for transplantation. Consequently, a number of seedling containers have been proposed in recent years in which the containers are made of a plantable material that is directly transplanted into the ground along with the seedlings with there being no need for removal of the seedlings from the container. While devices of this type have been fairly satisfactory, they do not possess the necessary rigidity to be easily handled without the aid of additional auxiliary support trays or the like. In fact, many non-plantable seedling containers are also so weak and fragile as to require the use of such supplemental containers or supports. Therefore, there has hitherto remained an unmet need for a reusable, economical and sturdy method and apparatus for handling and having the capacity of permitting the easy removal of seedlings from a container. For these reasons, it is the primary object of this invention to provide a new and improved planting apparatus.

### SUMMARY

A method and apparatus for planting seeds and growing plants comprises a base member housing one or more planting tubes and an extraction rod. In use, soil is placed in a planting tube with seedling thereby creating a potting medium. When the seedling grows to a desired size the planting tube is removed from the base member and placed over the extraction rod wherein it is gently pushed downward over the extraction rod thereby removing the potting medium and seedling from the planting tube for transplantation.

A better understanding of the invention will be had by the description that follows made in conjunction with the appended drawings.

### BRIEF DESCRIPTION OF THE DRAWING

FIG. 1 is an exploded perspective view of a preferred embodiment of the invention;

FIG. 2 is a perspective view of another preferred embodiment of the invention;

FIG. 3 illustrates the placement of soil thereby creating a potting medium for the invention shown in FIG. 2;

FIG. 4 illustrates plant growth in the potting medium after the soil placement shown in FIG. 3;

FIG. 5 is an exploded perspective view illustrating the configuration prior to removal of the potting medium; and

FIG. 6 is a perspective view of the potting medium being removed for transplantation in a field or the like.

### DETAILED DESCRIPTION OF THE DRAWINGS

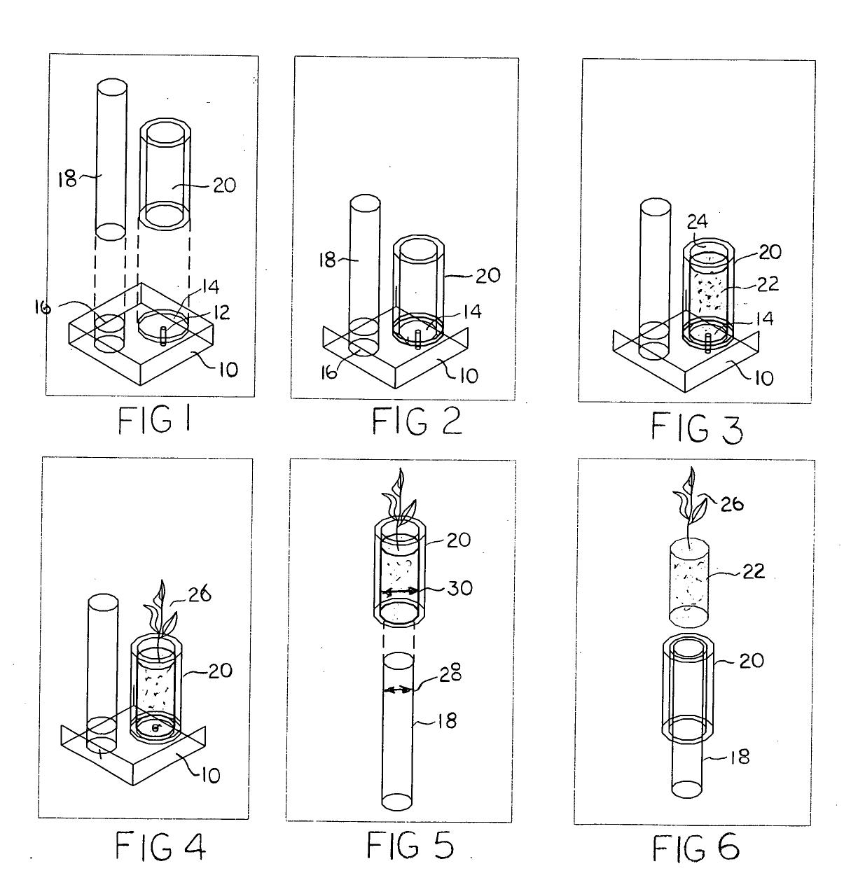

A method and apparatus for planting seeds and growing plants is shown in FIG. 1 comprising a base member 10, a planting tube 20 and an extraction rod 18. As shown in FIG. 1, the base member 10 is a generally rectangular structure defining two cavities 12 and 16 respectively wherein both cavities are sized for receiving and for detachably housing the planting tube 20 and extraction rod 18. As shown in FIG. 1, the planting tube 20 and extraction rod 18 are both cylindrical in shape wherein the two cavities 12 and 16 are similarly cylindrical for receiving the planting tube and extraction rod 20 and 18. Although not shown it should be understood that the cavities, rod and tube may be any shape, i.e., rectangular, square, oblong etc., and still use the method of the present invention as will be more fully described below.

Referring now to FIG. 2, the base member 10 has sufficient height such that its cavities 14 and 16 define a depth which allows the extraction rod or planting tube to set far enough down as to prevent either the extraction rod 18 or planting tube 20 from falling over or out of the base member 10. Another method of mounting the extraction rod 18 may be either a cavity through hole or blind hole using a screw attachment method (not shown) from underneath the base for using the blind hole to screw the extraction rod 18 to the base member 10. Turning once again to FIG. 2, at the center of the base of the cavity 16 is a drainage hole 14 which serves to release excess water as will be more fully explained below. The base member 10, planting tube 20 and extraction rod 18 may be made out of molded plastic or any material strong enough to hold their shape during handling.

As illustrated in FIG. 3, the plastic or planting tube 20 is inserted into the cavity 16 of base member 10 and is filled with dirt or soil from a package (not shown) creating a potting medium 22. In one embodiment, about ½ inch of space 24 is left from the top of the planting tube 20 after the soil is added. Seeds are now added and covered with an additional ¼″ of dirt or soil. Water may be gently added until moisture may clearly be seen on the inside walls of the planting tube 20 making sure that the seeds remain covered. In practice the potting medium is watered a little everyday or so if the dirt or soil appears dry.

As shown in FIG. 4, when given adequate sunlight and moisture, the seedling rapidly grows to a desired size. More specifically when the seedling sprouts 26 are approximately 1 to 2 inches high they are ready to transplant to a larger container or be transplanted outside. Although not shown, at this point an area should be prepared where the seedlings will be planted prior to removing them from their planting tube 20. Consequently, such seedlings may easily initiate growth following transplantation since the roots are not tightly entwined in a relatively solid mass.

As is clearly illustrated in FIGS. 5 and 6, the planting tube 20 is carefully removed from the base member 10 containing the potting medium 22 and place and located over the top of the extraction rod 18. The outer dimension or diameter 28 of the extraction rod 18 is sized to be fitted through the inner dimension or inner diameter 30 of the planting tube 20. In accordance with the method of the present invention, the planting tube 20 is gently slid over and pushed down over the extraction rod 18 until the potting medium 22 and seedling 26 are removed. This helps to protect the roots and seedling from transplant shock. The potting medium 22 and seedling may be planted immediately and watered.

Although reference has exclusively been made hereinabove to a single planting tube, it should be understood that the invention may work similarly with a plurality of planting tubes wherein the base member will have an equal number of cavities to receive each planting tube. In such a case, only one extraction rod is needed and similarly only one cavity in the base member to receive and store the extraction rod is required. Additionally, the base member is compact in nature allowing for ease of mobility in an indoor environment with the added benefit that bird's can't get to and eat the seedlings before they sprout as they could if the seedlings we're planted outside.

While advantageous embodiments have been chosen to illustrate the invention, it will be understood by those skilled in the art that various changes and modifications may be made therein without departing from the scope of the invention as defined in the appended claims.

What is claimed is:

1. A method for planting seeds and growing plants, comprising:
locating a planting tube within a base member;
filling said planting tube with soil and seedling creating a potting medium;
removing said planting tube from said base member when said seedling has grown to a desired size;
placing said planting tube over an extraction rod sized to fit within said planting tube; and
gently sliding over and pushing down said planting tube over said extraction rod until the potting medium and seedling are removed.

2. A method for planting seeds and growing plants according to claim 1, further comprising:
placing the soil until about ½ inch of space is left from a top of said planting tube.

3. A method for planting seeds and growing plants according to claim 2, further comprising:
covering said seedlings with an additional ¼″ of soil.

4. A method for planting seeds and growing plants according to claim 3, further comprising:
adding water gently until moisture may clearly be seen on inside walls of said planting tube making sure that the seeds remain covered.

5. A method for planting seeds and growing plants according to claim 3, further comprising:
transplanting the seedlings when they sprout about 1 to 2 inches high.

6. A method for planting seeds and growing plants according to claim 1, further comprising:
locating said extraction rod within said base member.

7. A method for planting seeds and growing plants according to claim 1, further comprising:
defining a plurality of cavities within said base member for detachably housing said planting tube and said extraction rod.

8. A method for planting seeds and growing plants according to claim 1, further comprising:
sizing an outer diameter of said extraction rod dimensioned to fit within an inner diameter of said planting tube.

9. A method for planting seeds and growing plants according to claim 1, wherein said planting tube and said extraction rod are cylindrical.

10. An apparatus for planting seeds and growing plants, comprising:
a base member housing of one or more planting tubes and an extraction rod wherein in use soil is placed in said planting tube with seedling thereby creating a potting medium and when the seedling grows to a desired size said planting tube is removed from said base member and placed over said extraction rod wherein it is gently pushed downward over said extraction rod thereby removing the potting medium and seedling from said planting tube for transplantation.

11. An apparatus for planting seeds and growing plants according to claim 10, wherein the soil is placed until approximately ½ inch of space is left from a top of said planting tube.

12. An apparatus for planting seeds and growing plants according to claim 11, wherein the seedlings are covered with an additional ¼″ of soil

13. An apparatus for planting seeds and growing plants according to claim 12, wherein water is gently added until moisture may clearly be seen on inside walls of said planting tube making sure that the seeds remain covered.

14. An apparatus for planting seeds and growing plants according to claim 11, wherein the desired size is when the seedlings sprout about 1 to 2 inches high.

15. An apparatus for planting seeds and growing plants according to claim 11, wherein mounting said extraction rod may be either a cavity through hole or blind hole using a screw attachment from underneath said base member for using said blind hole to screw said extraction rod to said base member.

16. An apparatus for planting seeds and growing plants according to claim 11, wherein said planting tube and said extraction rod are cylindrical.

17. An apparatus for planting seeds and growing plants according to claim 11, wherein an outer diameter of said extraction rod is dimensioned to fit within an inner diameter of said planting tube.

18. An apparatus for planting seeds and growing plants according to claim 11, wherein said base member, planting tube and extraction rod are made from plastic, or a plastic like material.

19. An apparatus for planting seeds and growing plants according to claim 11, wherein a drainage hole is provided for releasing excess water.

20. A method for planting seeds and growing plants, comprising:
locating a plurality of planting tubes within a base member;
filling said plurality of planting tubes with soil and seedling creating a plurality of potting mediums;
removing said plurality of planting tubes from said base member when said seedlings have grown to a desired size;
placing said plurality of planting tubes one at a time over an extraction rod sized to fit within said each planting tube; and
gently sliding over and pushing down each said planting tube over said extraction rod until the potting mediums and seedlings are removed from each said planting tube.
